(19) United States
(12) Patent Application Publication
(10) Pub. No.: US 2008/0208959 A1
(43) Pub. Date: Aug. 28, 2008

(54) Hanging request system and method for client/server communication

(76) Inventor: Sean St. John, Jupiter, FL (US)

Correspondence Address: Sean St. John;PMB 193, Suite 22, 5500 Military Trail, Jupiter, FL, 33458, US

(21) Appl. No.: 11/709,503

(22) Filed: Feb. 22, 2007

(51) Int. Cl. G06F 15/16

(52) U.S. Cl. 709/203

(57) ABSTRACT

A communication system for a computer network is described. The system has a Client Process configured to open a connection for requesting and receiving data across the computer network and a web server process operating on a web server configured to respond to a request across the computer network. The Client Process issues a hanging request to the web server process. The hanging request contains from zero to many event subscription demands. The hanging request maintains the connection to the web server process open. The web server process, in response to the hanging request, generates an event notification when an event occurs. The event notification is sent to the Client Process and the web server process closes the open connection after transmission of the event notification. The Client Process can further open a subsequent hanging request connection to the Web Server process. The Client Process is configured to detect an undesired disconnection from the web server process and can reconnect to the web server process by reissuing the hanging request.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark office, patent file or records, but otherwise reserves all copyright rights whatsoever.

### FIELD OF THE INVENTION

The present invention relates generally to Web Server technology. More particularly, the invention relates to Web Server process technology utilizing a hanging HTTP(S) request (HHR) method of communication between a Client and a Server.

### BACKGROUND OF THE INVENTION

A Client is defined herein as a process that is a consumer of the output generated by a Web Server process. A Process is any software that is in a state of activation, that is to say software that is running, in a CPU of a computer. A Web Server denotes a typical server computer that is usually connected to requesting Clients via a network or an interconnected series of networks. However, this is not always the case, such as, without limitation, when Clients may reside on the server computer. Some examples of connectivity include, without limitation, the Internet, Wide Area Networks (WAN), Local Area Networks (LAN), Wireless networks (Wi-fi), etc. The Web Server computer is responsible for the delegation of incoming Requests to the appropriate processes for handling, and likewise, the Web Server is responsible for transmitting the resultant responses from those processes, back to the originating Client.

A typical LAN configuration provides connectivity without restrictions. In this configuration a Client may communicate any information at any time to a Web Server process, and the Web Server process may communicate any information at any time to the Client. If the Web Server(s) is located on the Internet, the Client potentially has access to a much larger amount of information from many sources, however, the risk of receiving malicious information, or having the security of the computer and local network compromised by external perpetrators, increases sharply when the Client is exposed beyond the safety of the privately managed network. Some of these risks are, for example, without limitation, virtues, denial-of-service attacks, port-scans, etc.

To block undesirable exposure to external perpetrators, the Client may build a firewall between himself and the Web Server. This firewall defines discrete channels on the network connection, (called ports), that typically can only be opened from the Client's side of the firewall. These ports include without limitation, one or more main ports that typically remain available for Clients to utilize, for example, without limitation, an http port 80 and an https port 443, that are always available from the Client's side of the firewall, and yet still closed to external access. HTTP is an Internet standard format for initiating a request to a Web Server process, typically through port 80. HTTPS is an internet standard format for initiating a request that is encrypted with a secure socket layer (SSL) protocol, to a Web Server process, typically through port 443. A Web Server process is a type of process that operates on a Web Server computer and typically responds to a HTTP requests, HTTPS requests, and in the case of a Web Service, simple object access protocol (SOAP) requests. SOAP is a common communications protocol used for communicating between Client and Web Server processes. SOAP is based on the more primitive extensible markup language (XML) based protocol. XML is a simple protocol commonly used for a wide variety of applications. A protocol is any specific definition for a communication standard. SSL is a high-level encryption protocol used to conceal data from potential observers while in transport between network endpoints. These ports enable the Client to communicate to entities on the other side of the firewall by opening a port to the external network, and, when the communication is finished, the port is closed when the connection is terminated. If no firewall ports have been left open through the firewall from the outside (e.g., from the Internet), then this example represents a typical firewall configuration set at maximum security.

The problem introduced with the firewall is that neither the Web Server's processes nor any of the processes located on other entities connected to the Web Server are able to open nay of the Client's firewall ports to be able to notify the Client of something important. These entities must wait until the Client decides to first open the port by requesting information from the Web Server process. This is typical of client to web server connectivity on the Internet today; a request must be made before information can travel from the Web Server process to the Client.

If the Client requires timely information, the Client may decide to use a cyclical round-robin polling method of regularly requesting any new information available from the Web Server process. However, this method is a relatively slow, inefficient, wasteful, untimely, and expensive means of staying current.

Therefore, the Client's administrator, who oversees Client configuration, may decide that in order to receive information in a timely manner, the Web Server process must be able to initiate a message to the Client. A message is data transferred between computers. A message may also be referred to as a notification. To achieve this with conventional approaches, currently the Client's administrator spends a considerable amount of time configuring the firewall in order to unlock and open one or more ports such that these ports would be accessible externally (e.g. via the Internet), such that if a Web Server process desires to notify the Client of something, it may communicate directly with the Client through the open port. The problem with this method is that usually any entity on the Web Server's side of the firewall can utilize this port for access to the Client's network and computers, which may be undesirable or dangerous for the Client.

One of the major shortcomings of modern Web Server process technology is that it is typically in the form of request/response, meaning that a Client must initiate a connection to the Web Server, to which a process on the Web Server, for example, without limitation, generates a response that the Client consumes. A request-response cycle is the entire sequenced that encapsulates the Client initiating a request, the handling of that request by the Web Server process, and the response of the Web Server process being consumed by the Client. This system suffers from the shortcoming that it is often very difficult for the Client to be notified in real-time of events that may occur on a Web Server process that are of interest to the Client, simply because the Web Server process is typically not allowed to initiate a connection to the Client. This shortcoming makes it very difficult, if not impossible to provide a Client with real-time information from a Web Server process. In a real-time system, there are generally no built-in time delays, such as is introduced, for example, without limitation, by interval polling for updates; nor are there built-in potentially non-productive cycles, for example, without limitation, round-robin polling for updates, etc. To have Real-time processing usually implies that data is in a perpetual stat of motion, or queued in a queue that is actively being processed.

An event is any conceivable change in state of something that is being monitored by a process. Some examples might be, without limitation, a change in stock price, or temperature change, etc. A unique event identifier, for example, without limitation, an incrementing integer, can be used to uniquely identify each instance of any event occurrence that is managed by a Web Server process.

Currently, in order to facilitate Web Server process real-time notifications to the Client, at least two things must be true. First, the network connectivity from the Web Server to the Client must be configured to allow for messages from the Web Server process to be transmitted to the client uninterrupted. Second, the Client must be prepared to receive said messages from the Web Server process.

Fulfilling the second point is usually trivial for the Client. However, overcoming the first point is a much more difficult problem because it usually requires factors such as, but not limited to, time, expertise, network/firewall configuration, authentication, administrative authorization, etc. With firewall technology responding vigorously to the current, nascent epidemic of computer viruses, and network breaches plaguing the Internet, it has become quite a challenge to fortify personal/corporate networks from external intruders, while still remaining functionally capable of transmitting data between networks, especially via the Internet. To this end, virtually all externally originated information flow is unable to gain access to a network behind a firewall, making it quite difficult to send uncoordinated messages to a Client within that network.

A currently known method that attempts real-time event notification is called HTTP-Streaming. In HTTP-Streaming, the initial connection formed from a Client to a Web Server process is left open after some initial data may have been transferred from the Web Server process to the Client, in anticipation of sending more data, thereby keeping the connection perpetually open. One major downfall of HTTP-Streaming is that it suffers from proxy-caching latency issues, meaning that if the Client's network utilizes a proxy-cache process, it may buffer the Web Server process' data response on behalf of the Client, without actually passing it on to the client until the Web Server process' response has been completed (terminated) by the originating Web Server process. This makes HTTP-streaming unreliable in the context of real-time data transmissions.

Current implementations of sending a message through a firewall typically require cooperation between the firewall administrators, and the software in question, such that specific ports can be opened in the firewall, allowing for external server-initiated data transmissions to permeate the firewall via the agreed-upon port, which is then routed to the appropriate Client Process for handling. Of course, every firewall port that is opened becomes a weakness in the overall security level of the Client's network, and also requires costly administration in order to procure and maintain said port openings.

In view of the foregoing, there is a need for an improved method of communication between a Client and a Web Server process that enables the Client to receive event notifications from the Web Server's side of the firewall without the risk of allowing random entities to communicate any undesired information to the Client, or for them to gain access to the Client's network and computers via externally open ports.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary HHR, real-time, Internet-compatible event notification system, in accordance with an embodiment of the present invention;

FIG. 2 illustrates an exemplary HHR, real-time, Internet-compatible event notification system comprising a Conduit Client, in accordance with an embodiment of the present invention;

FIG. 3 is a flowchart of an exemplary HHR Client request/response processing cycle, in accordance with an embodiment of the present invention;

FIG. 4 is a flowchart of an exemplary HHR Client request/response processing cycle involving a Conduit Client, in accordance with an embodiment of the present invention;

FIG. 5 is a flow chart showing a basic exemplary Push-style technology, implemented as a process on a Web Server, in accordance with an embodiment of the present invention;

FIG. 6 is a flowchart showing a more robust embodiment of an exemplary Web Server process' request/response processing flow utilizing HHR, in accordance with an embodiment of the present invention; and

FIG. 7 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a system, method and computer program product for a hanging request system and method for client/server communication is described.

In one embodiment, a communication system for a computer network is described. The system has a Client Process configured to open at least one connection for requesting and receiving data across the computer network and a web server configured to respond to at least one request from the Client Process across the computer network. The Client Process issues a hanging request to the web server process. The hanging request is configurable to contain from zero to several event types that the Client wishes to be notified of. The hanging request maintains an open connection to the web server process. When an event of interest to the Client occurs on the Web Server process, the web server process in response to the hanging request generates an event notification. The event notification being sent to the Client Process, then the Web Server process terminates the hanging request. In further embodiments, the Client Process is further configured to open a subsequent hanging request to the Web Server process, and is further configured to detect an undesired disconnection from the web server process, and upon the disconnection, reconnecting a new hanging request to the web server process. Also an embodiment has a hanging request list. The hanging request list is configured to provide means for locating open hanging request connections, and the web server process being further configured to manage the hanging request list. The web server process is further configured to close and remove from the hanging request list at least one of the open hanging request connections when the event notification is sent. The web server process is also further configured to detect a reconnection from the Client Process and upon the reconnection the prior hanging request connection from that same Client is removed from the hanging request list. In a further embodiment, the Client Process is configured to issue a plurality of event subscription demands to the web server process. The system has a client subscription list, the client subscription list configured to contain at least the plurality of event subscriptions sent to the web server process, and the Client Process maintains the client subscription list. The system also has a web server process' subscription list. The web server process' subscription list configured to contain at least the plurality of event subscriptions demanded by Client Process. The web server process maintains the web server process' subscription list. In further embodiments, the Client Process is further configured to send indication to the web server process of a last event successfully received and the web server evaluates the indication to determine the success or failure of prior event notification transmissions to the Client. The Client Process is further configured to send the client subscription list's current state indicator to the web server process allowing the web server process to compare the client subscription list to the web server process' subscription list in order to maintain synchronization between the web server process' subscription list and the Client subscription list. The subscription state indicator is a pair of unique identifiers, for example, but not limited to, incrementing integers, one of which is the prior state identifier, and the other is the new state identifier. Each time the client modifies its Subscription list, the current new state identifier is relegated to the prior state identifier, and the Client then generates another new subscription state identifier. The Web Server process can use the subscription prior state identifier to confirm it has the same prior subscription for that client, and then after adjusting the Client subscriptions, records the subscription new state identifier for future subscription state comparisons. In additional embodiments, the system further has a plurality of additional Client Processes operable to send additional hanging requests to the web server process. The additional hanging requests configurable to contain a plurality of additional event subscription demands. The web server process maintains the additional hanging requests in the hanging request list and maintains the plurality of additional event subscriptions in the web server process' subscription list. In further embodiments, the web server process is further configured to send the event notification to one or more additional Client Processes. The Client Process and the additional Client Processes are configured to modify the plurality of subscribed events and plurality of additional event subscription demands, and send said modified event subscription demands to the web server process. The web server process is further configured to update the web server process' subscription list upon receipt of the modified event subscription demands.

In another embodiment, a communication system for a computer network is described. The system has a client means for sending and receiving data across the computer network, a server process means for responding to the client means, a request means for requesting data from the server process means, a notification means for responding to the request means, and a receiving means for receiving the response from the notification means. In a further embodiment, the system has a list means for maintaining lists of requests.

In yet another embodiment, a method of communicating over a computer network is shown. The method has the steps of providing a Client Process for sending and receiving data across the computer network, providing a web server process for responding to requests from the Client Process, creating a hanging request from the Client Process to the web server process, the hanging request opening a port to gain access to the web server process and maintaining the port open, the Client Process detecting a disconnection from the web server process and upon the disconnection, reopening the port to the web server process and reissuing the hanging request, sending an event notification from the web server process to the Client Process in response to the hanging request, and receiving the event notification in the Client Process and closing the port.

In still another embodiment, a method for a Client Process and a web server process to communicate over a computer network is described. The method has steps for the Client Process to request data from the web server process, steps for the Client Process to detect a disconnection from the web server process, steps for the web server process to respond to the request, and steps for the Client Process to receive the response from the web server process. In a further embodiment, the method includes steps for maintaining lists of requests.

In yet another embodiment, a computer program product for communicating over a computer network is described. The computer program product has a Client Process for sending and receiving data across the computer network and a web server process for responding to requests from the Client Process. Computer code creates a hanging request from the Client Process to the web server process. The hanging request automatically opens a port to gain access to the web server process and maintaining the port open. Computer code provides a means for the Client Process to detect a disconnection from the web server process and upon the disconnection, reopening the port to the web server process by reissuing the hanging request. Computer code sends an event notification from the web server process to the Client Process in response to the hanging request. Computer code receives the event notification in the Client Process and the web server process closes the hanging request connection which inherently closes the port. In a further embodiment, computer code for the Client Process reopens the port by sending a subsequent hanging request to the web server process upon the closing of the prior hanging request connection. Further embodiments include computer code for, a Web Server process' hanging request list configured to provide a means for locating open hanging request connections, closing and removing from the hanging request list at least one of the open hanging request connections when the event notification is sent to the Client Process, the Client Process to maintain a client subscription list containing at least the plurality of client event subscriptions demanded of the web server process, the web server process to maintain a web server process' subscription list, the web server process' subscription list containing at least the plurality of event subscriptions demanded by the Client Process, the Client Process to send indication to the web serve process of a last event successfully received, the Client Process to send the client subscription list to the web server process upon request of the web server process, the web server process to maintain the web server process' subscription list by comparing the client subscription list and the web server process' subscription list, providing for a plurality of additional Client Processes to send additional hanging requests to the web server process, the additional hanging requests configurable to contain a plurality of additional event subscription demands, the web server process to maintain the plurality of additional event subscriptions in the web serve process' subscription list, the web server process to send the event notification to one or more additional Client Processes, the Client Process and the additional Client Processes to determine if they need to modify the plurality of event subscriptions and plurality of additional event subscription demands, and to send modified event subscription demands to the web server process, and the web server process to update the web server process' subscription list upon receipt of the modified event subscription demands. In another embodiment, the computer program product resides on computer readable medium.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognized a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternatives embodiments do not necessarily imply that the two are mutually exclusive.

The present invention will now be described in detail with reference to embodiments thereof as illustrated in the accompanying drawings.

An aspect of the present invention is to leverage already commonly exercised and well-tolerated port-openings and protocols, in order to facilitate a secure, non-firewall-configuring means by which to grant external computers the ability to transmit Real-Time Event Notifications to a Client. An Event Notification is a message of any form consumable by the Client that contains details describing the nature of a Web Server process monitored or created event or events that have occurred. Embodiments of the present invention enable single or multiple Event Notifications to be sent together in a single response from a Web Server process to the Client.

Embodiments of the present invention transform conventional Pull-only Web Server process technology into Push-Pull-capable Web Server process technology, without firewall reconfiguration, such that Web Server process initiated Event notifications can be transmitted in real-time, through a firewall, to a Client. In conventional pull-only technology information must be requested from the Web Server process to be received from the Web Server process by the Client. Push-pull technology enables the Web Server process to request and transmit information to the Client at will.

Embodiments of the present embodiment accomplish this with a Hanging HTTP(S) Request (HHR) technique. An HHR is a standard HTTP or HTTPS request originated by a Client to a Web Server process, that is not responded to until the Web Server process has an appropriate response to give, effectively forcing the Client to wait. In these embodiments, the Client initiates an HHR used to initiate a connection between the Client and the Web Server process, which can be in SOAP format for Web Server requests, to which the receiving Web Server process only responds when it has an appropriate response to give. Effectively, the Client is left waiting for the Web Server process to reply.

This overcomes the first point of facilitating Web Server process real-time notifications to the Client described in the Background of the Invention section above by allowing the Client to create a temporary, endpoint-specific opening in the firewall by which the Web Server process can, at its leisure, elect to transmit Event Notifications to the Client by encapsulating these Event Notifications within the pending response to the original HHR. Because this connection is opened as a Client-side request to a specific Web Server in specific embodiments, no other computer but the desired Web Server is able to access this firewall opening and as such, the security level of the firewall remains indistinguishable from an HTTP(S)-enabled firewall.

These embodiments are not to be confused with the technique of HTTP-Streaming. The HHR method differs because the Web Server process does not send any data until the Web Serve process has an Event Notification(s) to provide to the Client. At this point, the Web Server process sends a complete message, then immediately closes the connection, thereby forcing any possible Client-side proxy-cache to immediately pass on this Event Notification to the Client Process without delay.

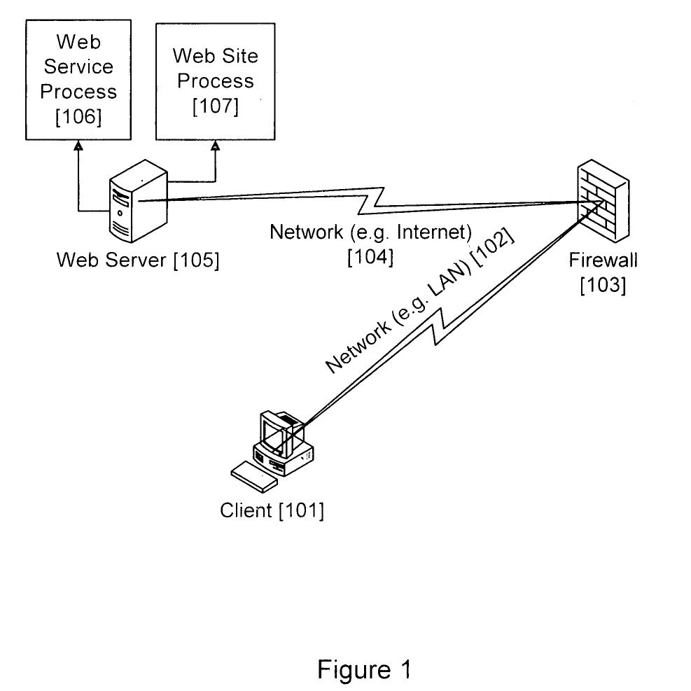

FIG. 1 illustrates an exemplary HHR, real-time, Internet-compatible event notification system, in accordance with an embodiment of the present invention. This is an exemplary embodiment, and those skilled in the art in light of the present teachings will recognize that many permutations exist due to the myriad of ways for computers to communicate. In the present embodiment, a Client computer 101 is the computer that wishes to receive Event Notifications from a Web Server process 105. Client computer 101 is connected to Web Server 105 via a LAN 102, through a firewall 103 via the Internet 104. Various Web Server processes such as, but not limited to a Web Service process 106 or a Web Site Process 107, are capable of handling incoming requests to Web Server 105, and subsequently generating a response for Web Server 105 with which to reply to Client computer 101.

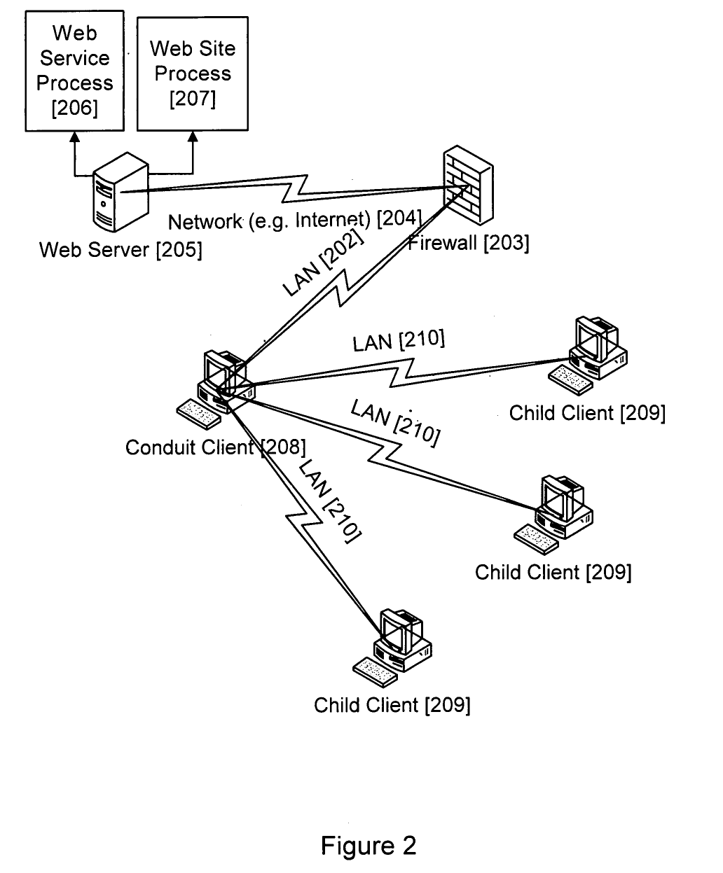

FIG. 2 illustrates an exemplary HHR, real-time, Internet-compatible event notification system comprising a Conduit Client 208, in accordance with an embodiment of the present invention. A Conduit is a Client that serves as a gateway for other Clients, in that the Conduit requests to be notified of Events by making Event Subscription demands, to a Web Server process, on behalf of Clients, and receives Event Notifications on those Client's behalf, and then forwards those Event Notifications to the Client(s). Event Subscription demands are instructions from clients to be notified of certain Events that occur on a Web Server process. Event is the chosen word here; however, synonyms such as, but not limited to Message or Channel are implied as well. Any means by which a Client can subscribe to receive filtered and/or routed data transmissions is ultimately what is being described by Event Subscriptions.

A Subscription List, a list of Event Subscriptions that each Client is subscribed to, is maintained per Client by each individual Client, and a copy of all Client's Subscriptions is maintained by the Web Server Process. A Subscription state indicator, for example, without limitation, an incrementing integer or letter, represents the latest state of subscriptions. This Subscription state indicator is passed from Client to Web Server process in an HHR, and back in the response from the Web Server process, and the Subscription state indicator allows both parties to verify that what the Client has in their Subscription list, matches what the Web Server process believes is the Client's Subscription List.

Similar to the embodiment shown by way of example in FIG. 1, the present embodiment demonstrates how Child Clients 209 and Conduit Client 208 are interconnected and related. The present embodiment comprises Conduit Client 208, Child Clients 209, and a Web Server 205. The present embodiment also comprises a form of physical connection between Conduit Client 208 and Web Server 205, a LAN 202 and a network 204 such as but not limited to the Internet are shown by way of example in FIG. 2. However, those skilled in the art, in light of the present teachings will recognize that alternate connection means may be used. In some embodiments Clients may reside on the Web Server itself, thereby removing the need for external connectivity. The present embodiment also comprises one or more processes operating on Web Server 205 that can consume Client requests, and generate a response to Conduit Client 208. A Web Service process 206 and a Web Site process 207 are shown as exemplary processes in the present example.

The present embodiment also comprises a firewall 203 somewhere between Conduit Client 208 and Web Server 205 that is configured to have common ports for example, without limitation, the 80 http port and the 443 https port, open in order to grand Conduit Client 208 access to external network 204, for example, without limitation, the Internet. In the present embodiment Child Clients 209 are separated from Web Server 205 by Conduit Client 208 in order to optimize, consolidate, and reduce connectivity demands between Child Clients 209 and Web Server 205. Conduct Client 208 and Child Clients 209 may or may not reside on the same computer. If not, as shown in the present embodiment, these computers may, without limitation, be interconnected through a LAN 210. The present example illustrates Conduit Client 208 as managing Events for Child Clients 209. This enables Conduit Client 208 to shelter Child Clients 209 from inappropriate information. In alternate embodiments, a Conduit client may manage Events for other types of Clients, for example without limitation, clients in a workplace where the Conduit Client may prevent the Clients from viewing non-work related information during business hours.

In typical use, two scenarios define a typical HHR cycle in accordance with embodiments of the present invention. HHR cycles reiterate each other, interchangeably depending on the connectivity conditions, until the Client no longer wishes to receive Event Notifications from the Web Server process. In the first exemplary scenario, a Client makes an HHR request to a Web Server process. The Web Server process responds with an Event Notification, either immediately if a relevant Event has already occurred, or when the next relevant Event occurs. Then, the Client consumes the Event Notification and then re-establishes a subsequent HHR to the Web Server process. In the second exemplary scenario, a Client makes an HHR request to a Web Server process. Then, the Client is disconnected either immediately, or after some delay, from the Web Server process by one of several possibilities such as, but not limited to, timeout, Web Server overload, network failure, etc. A timeout occurs when the consumed time to complete a request-response cycle has exceeded preset limits, and the connection is broken. Web Server Overload occurs when the demand of the system has exceeded the capacity of the system. Ideally, the Client will eventually successfully re-establish a subsequent HHR to the Web Server process.

More specifically, the method used in these embodiments comprises the following steps. The firewall is configured to allow Client-originated HTTP and HTTPS requests, typically port 80 and port 443, to pass through uninhibited. Then the Client initiates an HHR to the Web Server process, which automatically opens the firewall port 80, for example without limitation, connecting the Client to the Web Server. This results in a response-pending state in which only the targeted Web Server process can respond to this Client's specific HHR request. The Web Server process then waits, possibly zero time, for an Event of interest to the Client to occur, for example, without limitation, that the Client's favorite stock has dipped 5%. The Web Server process then notifies the Client of this Event, closes the HHR, which then automatically closes the port in the context of this HHR only. Other requests that may have been made through this same port number, perhaps by, but not limited to, other processes, remain unaffected by the termination of this HHR's cycle completion. The Client then consumes this Event, and once again reopens the same port and repeats the process.

Utilization of a port by a Client is implied in a virtual manner, such that opening and closing of a given port by a process only applies to that specific process. It is possible for multiple simultaneous processes to utilize the same port number without interacting with each other. Statements indicating the opening of closing of a port only apply to the process being discussed, and other processes that may be utilizing the same port number remain unaffected in their independent port's status.

This is an exemplary Hanging HTTP(S) request (HHR) approach to enabling Server-side events that are capable of permeating a firewall. This is the mechanism by which Clients may circumvent firewall custom configuration, and to not increase exposure to attack, but still allowing for real-time events to immediately be pushed from a Web Server process to a Client.

This is a simplistic rendition of what a real-world embodiment might comprise for an exemplary Web-Server based Event Notification system. As with all typical Web Servers, the present embodiment can operate in parallel with many Clients being service by a single Web Server, each Client interacting with the Web Server processes in a compartmentalized manner such that they are oblivious to other potential Clients. The Web Server processes are capable of maintaining this individuality for each Client the Web Server process services by directing discrete Events to only those Clients that have subscribed to be notified of those specific Events.

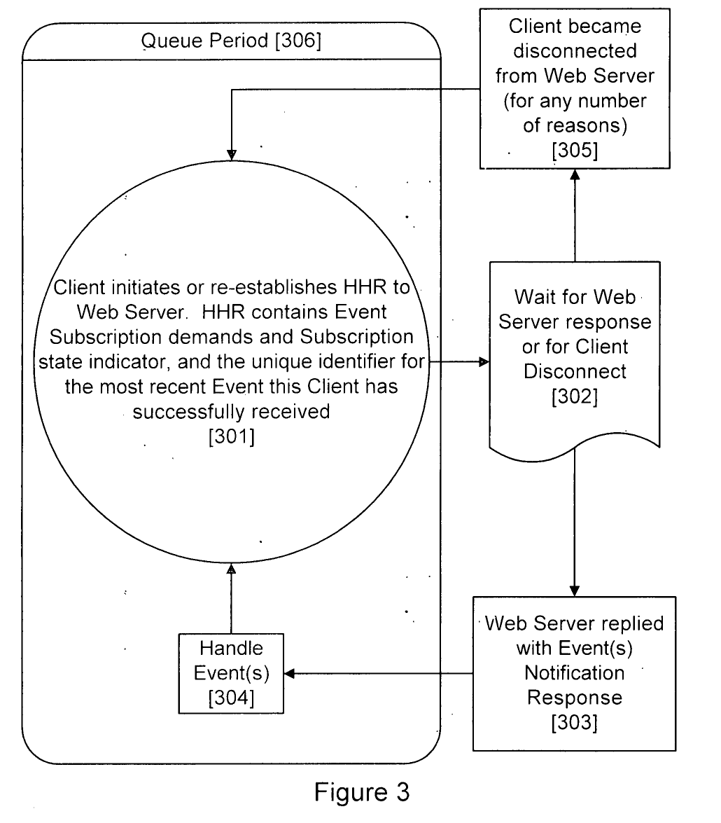

FIG. 3 is a flowchart of an exemplary HHR Client request/response processing cycle, in accordance with an embodiment of the present invention. To begin, the Client initiates or reestablishes an HHR to the Web Server process in step 301. The HHR optionally comprises Subscription data, and the identity of the last Event successfully received by the Client including, without limitation, the Subscription state indicator and Event unique identifier. The Subscription data is a list of add and remove demands that specify which Subscriptions to add, and which to remove for a particular Client in the Web Server process's Event Subscription List. If the Client wants to receive all Event Notifications from the Web Server process, the Concept of Subscriptions becomes superfluous and this functionality may not be necessary to implement and may not be included in some embodiments. In the present embodiment, The identity of the last Event successfully received is used by the Web Server process to determine which, if any, should be the next Event Notification(s) to send to the Client. This is also optional, and may not be included in some embodiments. However, this feature adds considerable reliability to the entire processing cycle since the Client is responsible for recovering lost Event Notifications due to occurrences such as, but not limited to network errors, server failures, etc.

After the Client initiates the HHR in step 301, the system waits for a response from the Web Server process or a Client Disconnect in step 302. A Client disconnect occurs when the connection between Client and Web Server process is broken prior to the completion of a successful request/response cycle. If the Web Server process sends an Event Notification(s), shown as step 303, the HHR is subsequently terminated, and the Event(s) are handled by the Client in step 304. Preferably, the Event(s) are handled asynchronously in a multi-threaded fashion and as soon as possible, enabling the opportunity for the immediate and parallel establishment of another HHR, which is vital for this to remain an effective real-time system. Multi-threading comprises multiple processes running concurrently to perform parallel tasks. Finally, the Client re-establishes another HHR to the Web Server process in step 301, either immediately in parallel with the Event processing, or after the Event processing.

If while waiting in step 302 for the Web Server process response, the Client's HHR request is unexpectedly terminated, as shown by step 305, the Client is returned to step 301 to attempt to re-establish another HHR to the Web Server process. A Client disconnect may occur due to reasons such as, but not limited to, a timeout, network technical issues, Web Server overload, Web Server unavailability, the Client wanting to update Subscriptions, etc. In the present embodiment, unless the Client no longer wishes to receive Event Notification from the Web Server process, the Client immediately reconnects when an Event Notification is received from the Web Server process or when network conditions prematurely disconnect the HHR request of the Client. This enables the Client to continue receiving Event Notifications.

A Queue Period 306 indicates the Client Processing that occurs when the Client does not have an active HHR connection to a Web Server process. Although typically a small fraction of the total request-response cycle time is spent in Queue Period 306, the Client is in a state where it temporarily cannot be notified of new Web Server process Events to which the Client may be Subscribed. During queue period 306, any Events that occur on the Web Server process to which the Client is Subscribed, are retained by the Web Server process such that when the Client finally does create another HHR in step 301, the Web Server process advances to step 303 and immediately replies with some or all relevant Event Notification(s).

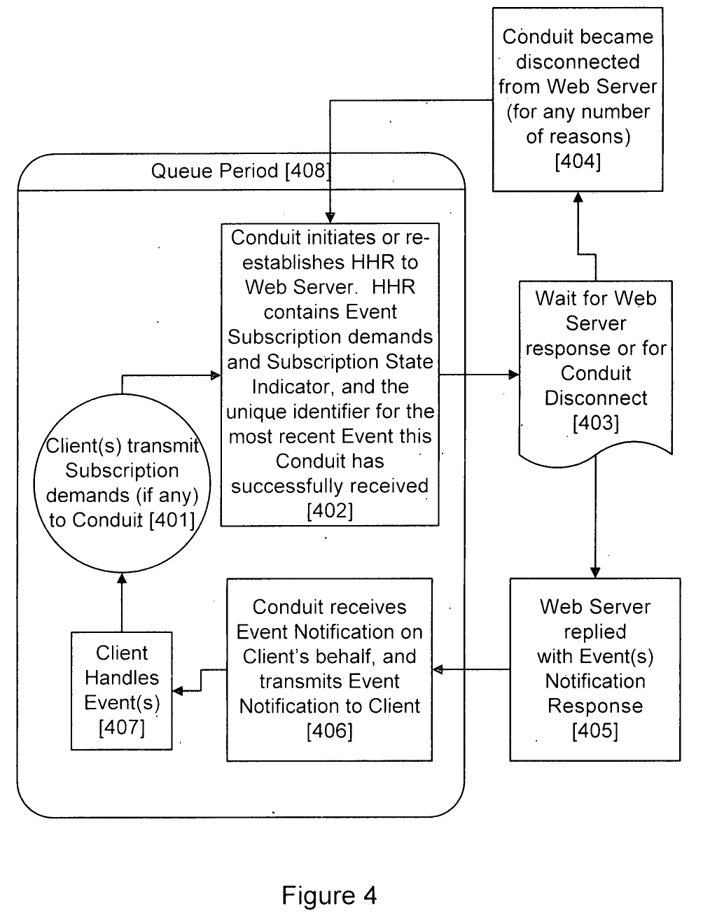

FIG. 4 is a flowchart of an exemplary HHR Client request/response processing cycle involving a Conduit, in accordance with an embodiment of the present invention. A Conduit may exit for Clients that may be running on the same computer, or different computers, such that the Conduit serves as a gateway to the Web Server processes that may be of interest to the Clients. The Conduit appears to the Clients to be the Web Server process that is providing Event Notifications; however, the Conduit forwards Subscription demands to the Web Server process on behalf of the Clients, and likewise the Conduit forwards Event Notifications on behalf of the Web Server process to the appropriate Clients. This configuration can be chained together such that an unlimited number of Conduits can form the eventual path between any given Client and the target Web Server.

In the present embodiment, Clients transmit Subscription demands to the Conduit in step 401. All Subscription demands from Clients are consolidated in the Conduit prior to the Conduit generating an HHR request to the Web Server process on the behalf of its connected Clients in Step 402. The HHR may comprise Event Subscription demands, Subscription state indicator, and the unique identifier for the most recent Event that the Conduit has received successfully. Then in step 403, the Conduit waits for the Web Server process to respond, or to be prematurely disconnected from the Web Server process for any number of reasons, for example, without limitation, new Client subscription demands, network problems, etc. If the Conduit is prematurely disconnected in step 404, the process returns to step 402 where the Conduit continuously attempts to reestablish another HHR to the Web Server process in step 404, until the Client no longer requires Event Notification from that Web Server process.

If the Web Server process replies with an Event Notification(s) in step 405, the Conduit receives the Event Notification(s) in step 406, and then distributes only the Client-relevant Event Notification(s) to all Clients that are subscribed to this Event(s). In step 407, each Client individually handles their copy of the Event Notification in tandem, or, in another incarnation, Clients receive Event Notifications in queue fashion such that the processing of a series of Event Notifications can be divided amongst the Clients, instead of duplicated for each Client.

If at any point during this cycle, the clients decide to change their Subscriptions, the Client may make these Subscriptions demands to the Conduit in step 401, and the Conduit forwards these Subscription demands to the Web Server process in a new HHR in step 402.

A Queue Period 408 indicates the period of time that transpires when the Conduit does not have an active HHR connection to a Web Server process. During Queue Period 408, any Events that occur on the Web Server process to which the Conduit is Subscribed to on behalf of its Clients, are retained by the Web Server process such that when the Conduit does create another HHR in step 402, the Web Serve process advances to step 405 and immediately replies with some or all relevant Event Notification(s).

The present embodiment comprises the following elements: a Client or Clients that wish to be notified of Events that occur in a Web Server process; connectivity between the Client(s) and the Web Server; or alternatively, connectivity between the Client(s) and the Conduit and the Web Server, and a Web Server that has processes actively running that are configured to receive HHR requests from the Client or the Conduit. Also, the Client has the ability to determine when the connection to the Web Server or Conduit has been undesirably severed prior to receiving an Event Notification, and the Conduit has the ability to determine when the connection to the Web Server has been undesirably severed prior to receiving an Event Notification. In the present embodiment, the Client has the ability to receive Event Notifications from the Web Server process or Conduit; the conduit has the ability to receive Event Notifications from the Web Server process; the Conduit has the ability to forward Event Notifications to appropriate Clients; and the Clients have the ability to process Event Notifications. Additionally, the Client and the Conduit should have enough processing speed and allocated CPU time to be able to perform their individual functionality in a timely fashion.

Optionally, the present embodiment may enable the Client and/or the Conduit to transmit a Subscription demand embedded in the HHR, or as a separate request altogether. In some embodiments, the Client and/or the Conduit may send the unique identifier of the last Event it received successfully, to allow Web Server process to determine the success or failure of any Event Notifications that it had previously attempted to send to the Client.

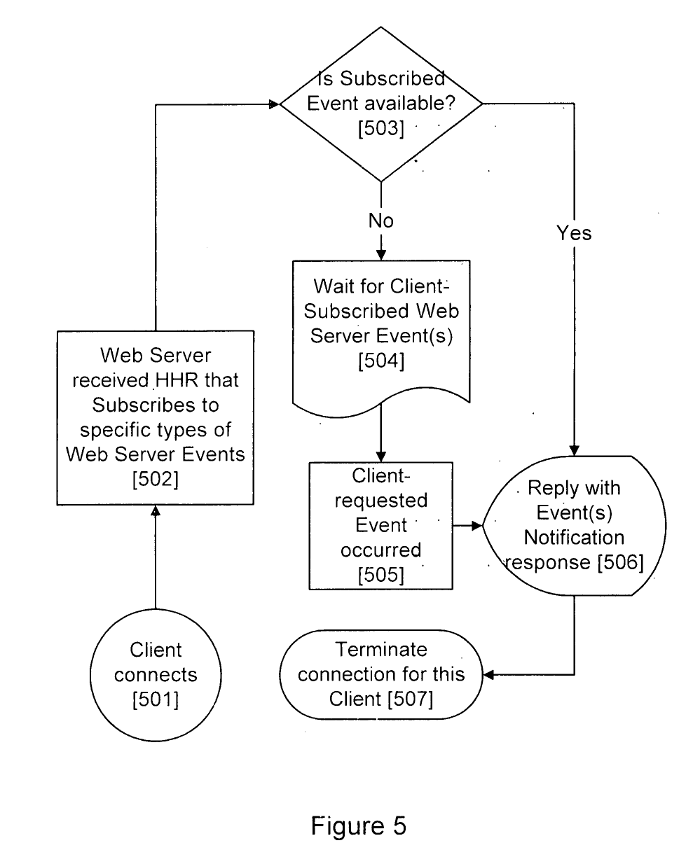

FIG. 5 is a flow chart showing exemplary Push-style technology implemented as a process on a Web Server, in accordance with an embodiment of the present invention. FIGS. 3 and 4 demonstrate the Client portion of an HHR transaction, and FIG. 5 demonstrates the Web Server process portion of the same HHR transaction.

In the present embodiment, the processing cycle begins at step 501 where a Client initiates a connection to the Web Server process in the form of an HHR. In step 502, the Web server process receives the HHR that subscribes to specific types of Web Server Events. The appropriate Web Server process parses the request in order to extract pertinent information such as, but not limited to, Subscription add/remove demands, unique identifier of the last Event successfully received by client, client Subscription state indicator, etc. The Web Server process then determines if there are any queued Events that need to be immediately transmitted to the Client in step 503. If so, an Event Notification is sent to the Client in step 506, and the connection to that Client is closed in step 507. If there are no pending Events for that Client in step 503, the Web Server process puts that Client's connection into a stand-by state in step 504. The Client's connection remains in this stand-by state until a relevant Event(s) occurs, shown as step 505, at which point an Event Notification(s) is sent to the Client in step 506, and the connection to that Client is closed in step 507.

The present embodiment comprises a Web Server process that consumes HHR requests. The Web Server process can also determine if an Event Notification should be sent, immediately if there are pending Events, or when an Event occurs. The Web Server process can also determine which Events Notifications should be sent to the Client. Also, in the present embodiment, the Web Server can end a Client's HHR request.

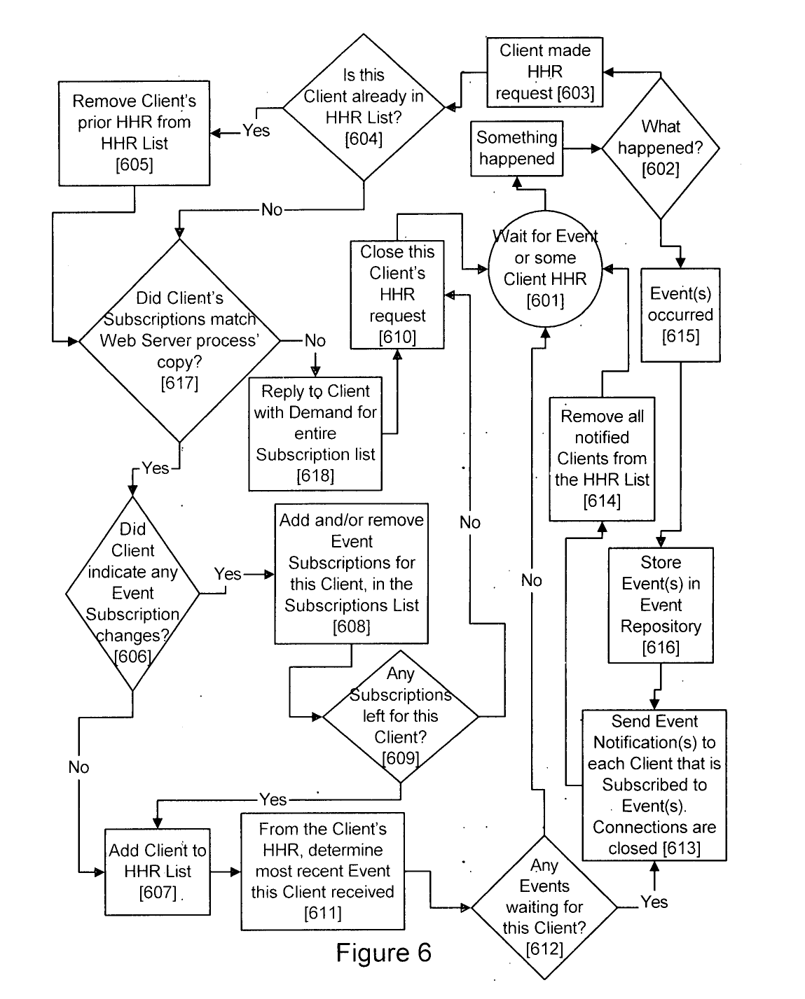

FIG. 6 is a flowchart showing an exemplary Web Server process' request/response processing flow utilizing HHR, in accordance with an embodiment of the present invention. FIG. 6 shows by way of example, a technique by which the Web Server process can confirm a successful transmission of an Event Notification to a Client, that being that the Client is always re-establishing an HHR that contains the unique identifier of the most recent Event the Client has successfully received. In this way, it becomes virtually impossible for Event Notifications to be lost or skipped due to Client/Web Server connectivity issues.

In the present embodiment, the Client-side process is as demonstrated, by way of example, in FIGS. 3 and 4. FIG. 6 demonstrates, by way of example, a fully functional prototype of the Server-side processing necessary to realize a Web Server process Push mechanism. The processing cycle begins at step 601, which is an initial wait state of the Web Server process when this process cycle is instantiated. The system remains in this state until an Event occurs, or the Web Server process receives an incoming HHR from a Client. The Web Server process determines what has occurred in step 602. If the occurrence is an incoming HHR from a Client, as shown in step 603, the Web Server process first determines whether this Client already exists in its HHR List in step 604.

The HHR list is a Web Server-side list of Client Requests that remain open and waiting for responses. The HHR List comprises open Client HHR connections such that when a relevant Event occurs, the respective Client connections can be located and subsequently sent an Event Notification, then those connections are closed. Client connections are removed from the HHR List when they are known to no longer be connected, for example, without limitation, after an Event Notification is sent, or due to network conditions. Also, a Client's old connection entry is removed from the HHR List when that Client reconnects. This scenario occurs when a Client connection is broken without the Web Server process's knowledge and deleting the original entry will prevent Event Notifications from being sent to the Client's now obsolete prior HHR request connection. If upon making an HHR request, the Client already exists on the HHR List, then the Client was previously disconnected without the Web Server process' knowledge, and in step 605, the HHR List is adjusted to remove the old obsolete entry for this Client. If the Client does not exist, the HHR List is not adjusted, and the process continues to step 617.

In step 617, the system determines if the Subscription state indicator that was sent in the HHR matches the Subscription state indicator that the Web Server process has stored for that Client. If this does not match, what the Client believes is its Subscriptions, are out of synch with what the Web Server process has for that Client's Subscriptions. When this occurs, a response is sent to the Client in step 618 that specifies that the Client must immediately re-establish another HHR with an entire set of Subscription demands, as opposed to only the changes that it normally would, so that the Web Server process can define this Client's exact Subscription list. The Client's HHR request is then closed in step 610, and the process returns to the wait state at step 601.

If the Client's Subscription state indicator matches the Web Server process' Subscription state indicator in step 617, the process continues to step 606. In step 606, it is determined if any Subscription changes have been received, for example, without limitation, embedded in the HHR, from the Client. If changes to the Subscription List are indicated by the Client, The Subscription List is modified to reflect the Event Subscription changes demanded by the Client in step 608. In the present embodiment, the Subscription List maintains the relationship between Clients and the Events to which they are subscribed. At this point, it is determined whether this Client has any remaining Subscriptions in step 609. If not, the Client connection is closed in step 610, and the Web Server process returns to the wait state in step 601.

If there are Subscriptions remaining for this Client in step 609, or if no Subscription modifications were demanded in step 606, the Web Server process adds this Client's connection to its HHR List in step 607, such that this open connection can be retrieved at a later time.

The next step in the processing cycle, step 611, is to extract from the Client's HHR request, the unique identifier of the last Event successfully received by the client. This bit of data tells the Web Server process exactly which Event the Client successfully received last. The Web Server process then searches its Event Repository for any Subscribed Event(s) that follow the one identified by the supplied Event unique identifier in step 612. All Events that occur in a Web Server process are stored in the Event Repository to allow for later retrieval. This can be implemented through various means such as, but not limited to, an in-memory queue, a table in a database, etc. The Event Repository may store the Events temporarily or permanently. In this way, even if an Event Notification is lost when sent to the Client, the Client will be re-issued the lost Event Notification by the Web Server process when the client successfully re-establishes an HHR with the most prior Event unique identifier that it received successfully.

If there are no Events that need to be sent to the Client in step 612, the Web Server process returns to the wait state in step 601. If there is an Event(s) that needs to be sent to the Client in step 612, the Client is replied to with some or all relevant Event(s), and the Client Connection is closed in step 613. Subsequently, the Client's HHR entry is removed from the HHR List in step 614, and finally, the Web Server process is returned to the wait state in step 601.

In the present embodiment, if the wait state 601 is broken and it is determined in step 602 that the wait state was interrupted by an Event shown in step 615, the Event is stored in the Event Repository in step 616. All Clients that are subscribed to this Event are replied to with an Event Notification, and those respective client connections are closed in step 613. Then, all Clients replied to in step 613 have their corresponding entries removed from the HHR List in step 614, and finally the Web Server process returns to the wait state in step 601.

In an alternate embodiment, this Web Server process can be run in multi-threaded fashion, such that parallel HHR requests can be processed simultaneously. Events that occur while the Web Server process is not yet in a wait state, will be queued until the Web Server process' wait state is achieved or, alternatively, be handled by another Web Server process thread.

An alternate embodiment may include, without limitation, two or more parallel HHR's from the Client to the Web Server process thereby reducing the Event Notification latency introduced by a Queue Period since there will be multiple HHR's that can sequentially accept very frequent Event Notifications from the Web Server process. The Queue Period is the period of time between when the Web Server process sends an Event Notification to the Client, until after the Client re-establishes an HHR connection to the Web Server process to continue listening for specified Events. Typically, any Events of interest to a Client that occur on the server process during the Queue Period will be queued until the Client re-establishes an HHR to the Web Server process. If any of the queued Events are specified in the newly re-established Client's Subscriptions, an Event(s) Notification containing those Event(s) details will be immediately sent back to the Client.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processing approaches and system modules, and is not limited to any particular computer hardware, software, middleware, firmware, microcode and the like.

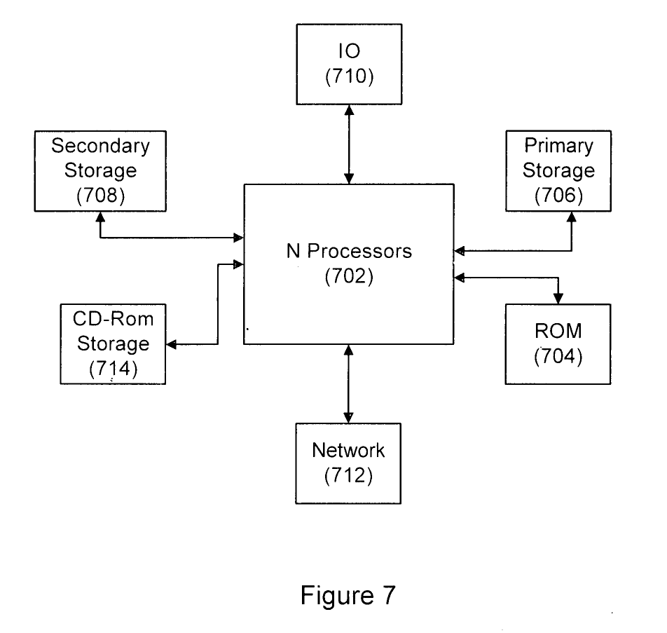

FIG. 7 illustrates a typical computer system that, when appropriately configured or designed, can serve as a computer system in which the invention may be embodied. The computer system 700 includes any number of processors 702 (also referred to as central processing units, or CPUs) that are coupled to storage devices including primary storage 706 (typically a random access memory or RAM), primary storage 704 (typically a read only memory, or ROM). CPU 702 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 704 acts to transfer data and instructions uni-directionally to the CPU and primary storage 706 is used typically to transfer data and instructions in a bi-directional manner. Both of these primary storage devices may include any suitable computer-readable media such as those described above. A mass storage device 708 may also be coupled bi-directionally to CPU 702 and provides additional data storage capacity and may include any of the computer-readable media described above. Mass storage device 708 may be used to store programs, data and the like and is typically a secondary storage medium such as a hard disk. It will be appreciated that the information retained within the mass storage device 708, may, in appropriate cases, be incorporated in standard fashion as part of primary storage 706 as virtual memory. A specific mass storage device such as a CD-ROM 714 may also pass data uni-directionally to the CPU.

CPU 702 may also be coupled to an interface 710 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 702 optionally may be coupled to an external device such as a database or a computer or telecommunications or internet network using an external connection as shown generally at 712, which may be implemented as a hardwired or wireless communications link using suitable conventional technologies. With such a connection, it is contemplated that the CPU might receive information from the network, or might output information to the network in the course of performing the method steps described in the teachings of the present invention.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, web server, firewall, conduit client 208, and/or possibly one child client 209 of the present invention may be performed and/or located outside of the jurisdiction of the USA the remaining novel method steps and/or system components of the forgoing embodiments are typically required to be located/performed in the US for practical considerations.

Having fully described at least one embodiment of the present invention, other equivalent or alternative means for implementing a hanging HTTP(S) request (HHR) method of communication between a Client and a Server according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A communication system for a computer network, the system comprising:
a Client Process configured to open at least one connection for requesting and receiving data across the computer network;
a web server process configured to respond to at least one request from said Client Process across the computer network;
a hanging request issued by said Client Process to said web server process, said hanging request being configurable to contain event subscription demands, said hanging request maintaining said connection to said web server process open; and
an event notification generated by said web server process in response to said hanging request, said event notification being sent to said Client Process whereby said web server process closes said open connection upon transmission of said event notification.

2. The system as recited in claim 1, in which said Client Process is further configured to open an subsequent hanging request connection to said web server process upon closure of said open connection.

3. The system as recited in claim 2, in which said Client Process is further configured to detect a disconnection from said web server process, and upon said disconnection, reconnecting said hanging request to said web server process.

4. The system as recited in claim 3, further comprising a hanging request list, said hanging request list configured to provide a means for adding or locating open hanging request connections, and said web server process being further configured to manage said hanging request list.

5. The system as recited in claim 4, in which said web server process is further configured to close and remove from said hanging request list at least one of said hanging request connections when said event notification is sent.

6. The system as recited in claim 5, in which said web server process is further configured to detect a reconnection due to recovering from a prior broken connection from said Client Process and upon said reconnection said respective prior open hanging request connections are removed from said hanging request list.

7. The system as recited in claim 6, in which said Client Process is configured to issue a plurality of event subscription demands to said web server process.

8. The system as recited in claim 7, further including a client subscription list, said client subscription list configured to contain at least said plurality of event subscriptions demanded of said web server process, and said Client Process further being configured to maintain said client subscription list.

9. The system as recited in claim 8, further comprising a web server process subscription list, said web server process subscription list configured to contain at least said plurality of event subscriptions demanded from Client Process, and said web server process further being configured to maintain said web server process subscription list.

10. The system as recited in claim 9, in which said Client Process is further configured to send indication to said web server process of a last event successfully received and said web server process being configured to evaluate said indication.

11. The system as recited in claim 130, in which said Client Process is further configured to send said client subscription list state indicator to said web server process and said web server process being further configured to utilize said client subscription list state indicator to determine accuracy of said Web Server process subscription list.

12. The system as recited in claim 11, further comprising a step of said Client Process sending said client's entire subscription list to said web server process upon request of said web server process.

13. The system as recited in claim 112, further comprising a plurality of additional Client Processes operable to send additional hanging requests to said web server process, said additional hanging requests configurable to contain a plurality of event subscription demands, said web server process maintaining said additional hanging requests in said hanging request list and maintaining said plurality of demanded event subscriptions in said web server process subscription list.

14. The system as recited in claim 133, in which said web server process is further configured to send said event notification to one or more additional Client Processes.

15. A communication system for a computer network, the system comprising:
a client means for sending and receiving data across the computer network;
a server means for listening for and responding to said client means;
a request means for requesting data from said server means;
a notification means for responding to said request means; and
a receiving means for receiving said response from said notification means.

16. The system as recited in claim 155, further comprising a list means for maintaining lists of requests.

17. A method of communicating over a computer network, the method comprising the steps of:
providing a Client Process for sending and receiving data across the computer network;
providing a web server process on a web server for responding to requests from said Client Process;
creating a hanging request from said Client Process to said web server process, said hanging request opening a port to said web server process and maintaining said port open;
said Client Process detecting a disconnection from said web server process and upon said disconnection, reopening said port by reissuing said hanging request to said web server process;
sending an event notification from said web server process to said Client Process in response to said hanging request; and
receiving said event notification in said Client Process and then Web Server process closing said hanging request which closes said port.

18. The method as recited in claim 17, further comprising a step of said Client Process reopening said port by sending a subsequent hanging request to said web server process upon said web server closing said hanging request which closes said port.

19. The method as recited in claim 18, further comprising a step of providing a hanging request list configured to provide a means for locating open hanging requests, said hanging request list being managed by said web server process.

20. The method as recited in claim 19, further comprising a step of said web server process removing from said hanging request list at least one of said hanging requests when said event notification is sent.

21. The method as recited in claim 20, in which said web server process is further configured to detect a reconnection due to recovering from a prior broken connection from said Client Process and upon said reconnection said respective prior open hanging request connections are removed from said hanging request list.

22. The method as recited in claim 21, further comprising a step of said Client Process issuing a plurality of event subscription demands to said web server process.

23. The method as recited in claim 22, further comprising a step of said Client Process maintaining a client subscription list containing at least said plurality of event subscription demands sent to said web server process.

24. The method as recited in claim 23, further comprising a step of said web server process maintaining a web server process subscription list, said web server process subscription list containing at least said plurality of event subscriptions demanded by said Client Process.

25. The method as recited in claim 24, further comprising a step of said Client Process sending indication to said web server process of a last event successfully received for said web server process to evaluate.

26. The method as recited in claim 25, in which said Client Process is further configured to send said client subscription list state indicator to said web server process and said web server process being further configured to utilize said client subscription list state indicator to determine accuracy of said Web Server process subscription list.

27. The method as recited in claim 26, further comprising a step of said Client Process sending said client's entire subscription list to said web server process upon a request from said web server process.

28. The method as recited in claim 27, further comprising a step of providing for a plurality of additional Client Processes operable to send additional hanging requests to said web server process, said additional hanging requests configurable to contain a plurality of event subscription demands.

29. The method as recited in claim 28, further comprising a step of said web server process maintaining said plurality of event subscription demands in said web server process subscription list.

30. The method as recited in claim 29, further comprising a step of said web server process sending said event notification to one or more additional Client Processes.

31. The method as recited in claim 30, further comprising a step of said Client Process and said additional Client Processes sending a plurality of said event subscription demands to said web server process.

32. The method as recited in claim 31, further comprising a step of said web server process updating said web server process subscription list upon receipt of said modified event subscription demands.

33. A emthod for a Client Process and a web server process to communicate over a computer network, the method comprising:
steps for the Client Process to request data from the web server process;
steps for the Client Process to detect a disconnection from the web server process;
steps for the web server process to listen for and respond to said request; and
steps for the Client Process to receive said response from the web server process.

34. The method as recited in claim 33, further including steps for maintaining lists of requests.

35. A computer program product for communicating over a computer network, the computer program product comprising:
a Client Process for sending and receiving data across the computer network;
computer web server code for responding to requests from said Client Process;
computer code for creating a hanging request from said Client Process to said web server process, said hanging request opening a port to said web server process and maintaining said port open;
computer code for providing a means for said Client Process to detect a disconnection from said web server process and upon said disconnection, reopening said port by reissuing said hanging request to said web server process;
computer code for sending an event notification from said web server process to said Client Process in response to said hanging request;
computer code for receiving said event notification in said Client Process and closing said port; and
a computer readable medium that stores the computer code.

36. The computer program product as recited in claim 35, further comprising computer code for said Client Process to open said port by sending a subsequent hanging request to said web server process upon closing said port.

37. The computer program product as recited in claim 36, further comprising computer code to provide a hanging request list configured to provide a means for locating open hanging requests.

38. The computer program product according to claim 37, wherein the computer-readable medium is one selected from the group consisting of a data signal embodied in a carrier wave, an optical disk, a hard disk, a floppy disk, a tape drive, a flash memory, and semiconductor memory.

39. A method of communicating over a computer network, the method comprising the steps of:
providing a Client Process for sending and receiving data across the computer network, the Client Process generating requests that are responded to by a web server process;
creating a hanging request from said Client Process to said web server process, said hanging request opening a port to said web server process and maintaining said port open;
said Client Process detecting a disconnection from said web server process and upon said disconnection, reopening said port by reissuing said hanging request to said web server process;
said Client Process receiving an event notification from said web server process, said event notification being generated in response to said hanging request; and
receiving said event notification in said Client Process then web server closing said hanging request which closes said port.
